(19) United States
(12) Patent Application Publication
(10) Pub. No.: US 2011/0020553 A1
(43) Pub. Date: Jan. 27, 2011

(54) ANTI-OXIDANT COATING FOR CARBON COMPOSITE DISKS

(75) Inventor: James Martin SHAMO, Lakeville, IN (US)

Correspondence Address: HONEYWELL/BSKB;PATENT SERVICES, 101 COLUMBIA ROAD, P.O. BOX 2245, MORRISTOWN, NJ, 07962-2245, US

(73) Assignee: HONEYWELL INTERNATIONAL INC., Morristown, NJ (US)

(21) Appl. No.: 12/506,802

(22) Filed: Jul. 21, 2009

(51) Int. Cl. B05D 3/02; B05C 9/12

(52) U.S. Cl. 427/372.2; 118/58

(57) ABSTRACT

A method for antioxidant coating a carbon composite disk (10) includes providing an ink antioxidant (14) having a pigmentation, applying the ink antioxidant (14) on the non-friction surfaces (12) of the carbon composite disk (10) to create an ink antioxidant coated carbon composite disk (20), and drying the ink antioxidant coated carbon composite disk (20).

### FIELD OF THE INVENTION

This invention relates to an apparatus and method for improving antioxidant coating for carbon composite disks. The apparatus and method of the present invention are especially suitable for protecting aircraft brakes containing carbon composite disks.

### BACKGROUND OF THE INVENTION

Carbon composite disks are known for their excellent performance in high temperature applications. Their ability to provide exceptional frictional force while absorbing a large amount of thermal energy created during stops associated with aircraft landings is especially desired. However, there is a challenge to protect aircraft brakes containing carbon composite disks from thermal and catalytic oxidation. In general, the carbon composite disks are treated with antioxidant coatings to protect non-friction surfaces from oxidation. The types of antioxidant coating can vary but a majority of such coatings, such as phosphate penetrants, are difficult to apply consistently due to lack of pigmentation. An unevenly applied antioxidant coating can lead to oxidation that would compromise the structural integrity of the carbon composite disks and cause disk failure. Improperly applied antioxidant coating, such as application to the friction surfaces of a carbon composite disk, can lead to modified friction performance. In addition, a majority of types of antioxidant coating require a special drying cycle, i.e. a high temperature furnace. Therefore, there is a problem of cost and time associated with the post-cure of antioxidant coating applications.

### SUMMARY OF THE INVENTION

This invention relates to an apparatus and method for improving antioxidant coating for carbon composite disks. The apparatus and method of the present invention are especially suitable for protecting aircraft brakes containing carbon composite disks. These problems and others are addressed by embodiments of the present invention. One embodiment of the present invention is a method for antioxidant coating a carbon composite disk including: providing an ink antioxidant having a pigmentation, applying the ink antioxidant on the non-friction surfaces of the carbon composite disk to create an ink antioxidant coated carbon composite disk, and drying the antioxidant ink coated carbon composite disk.

Another embodiment of the present invention is an apparatus for antioxidant coating a carbon composite disk including: a storing unit to store an ink antioxidant having a pigmentation; an applying unit to apply the stored ink antioxidant on the non-friction surfaces of the carbon composite disk to create an ink antioxidant coated carbon composite disk, and a drying unit to dry the ink antioxidant coated carbon composite disk.

### BRIEF DESCRIPTION OF THE DRAWING

The present invention will be more fully understood by reference to the detailed description given herebelow and to the accompany drawings. The drawings are not to scale, and are provided by way of illustration only. The drawings do not in any way limit the present invention.

FIG. 1 is an illustration of an embodiment of application of ink antioxidant to the non-friction surfaces of a carbon composite disk.

FIG. 2 is an illustration of an embodiment of post-cure of an ink antioxidant coated carbon composite disk.

FIG. 3 is a flow chart of application of ink antioxidant to the non-friction surfaces of a carbon composite disk and the post-cure in an embodiment.

FIG. 4 is an illustration of a system for application of ink antioxidant to the non-friction surfaces of a carbon composite disk and the post-cure in an embodiment.

### DETAILED DESCRIPTION OF THE INVENTION

Typically, ink is used to print a part number on a carbon composite disk for a purpose of identification. It has been recognized that the part number printed in ink would still be visible on carbon composite disks that are damaged from oxidation. Thus, according to an aspect of the present invention, ink can be used as an antioxidant coating to create an ink coated carbon composite disk.

Unlike some traditional kinds of antioxidant coating such as phosphate penetrants, which are transparent in nature, ink already has a pigment in it to provide visual detection during the application process. This allows a person to visually detect an applying area as well as a coating thickness to ensure a uniform and even coating. In addition, a majority of types of antioxidant coatings requires some degree of furnace treatment, whether it be a char or a post-cure at an elevated temperature for a given period of time. Since ink can be dried in a relatively low temperature, a large amount of time in post application as well as curing time can be cut down. As a result, production cost can be decreased because the overall antioxidant coating process is simplified.

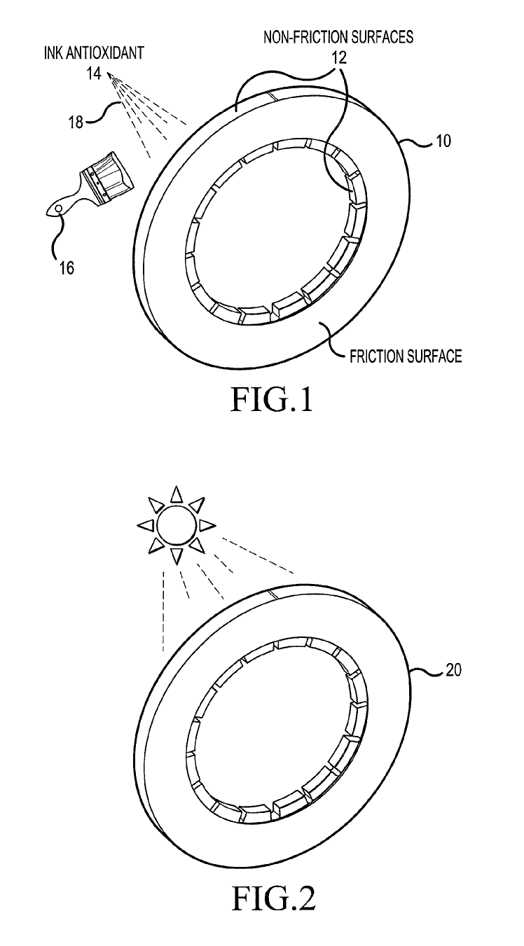

FIG. 1 illustrates an exemplary embodiment for applying an ink antioxidant 14 to the non-friction surfaces 12 of a carbon composite disk 10. The non-friction surfaces 12 may be uncoated of an existing antioxidant coating or coated of an existing antioxidant. The ink antioxidant 14 is obtained and applied by a brush 16 or a sprayer 18 to the non-friction surfaces 12 of the carbon composite disk 10. In one aspect, the ink antioxidant 14 is loaded into a standard plastic bottle with foam type dispensing head and applied to the carbon composite disk 10 per standard drawings and process. While a brush 16 and a sprayer 18 are illustrated, other alternative applicators may also be used. In addition, the brush 16 and sprayer 18 or other alternative applicators may be a part of an automated system for an application of the ink to the non-friction surfaces 12 of the carbon composite disk 10.

The ink antioxidant 14 contains pigmentation such as titanium oxide. The ink antioxidant 14 is applied, as a primary protection, to carbon composite disks that are uncoated of an existing antioxidant coating. When applying the ink to an unprotected disk, the ink could penetrate into the carbon porosity similar to existing antioxidant coating configurations. Alternatively, the antioxidant ink 14 can be applied to carbon composite disks having an existing antioxidant coating, i.e. a coating of phosphate penetrant, to provide a secondary protection.

Examples of the antioxidant ink 14 may contain 40-45% titanium oxide pigment, 20-30% shellac, 20-30% ethyl alcohol, 5-10% cellosolve solvent and 1-5% aluminum. The ink would offer the benefit of pigmentation to assist in the application, detectability and drying of the coating. The ink offers quicker application process and lower cost solution to antioxidant coating.

FIG. 2 illustrates an exemplary embodiment for post cure of an ink antioxidant coated carbon composite disk 20. The ink antioxidant coated carbon composite disk 20 is dried in a room temperature. Also, instead of drying the coated carbon composite disks in a room temperature, as an alterative, a slight version of char or furnace can be used for drying the ink antioxidant coated carbon composite disk 20. The slight version of char or furnace may be of relatively low temperature of 100-150 F., or relatively short process time for 1 to 2 hours.

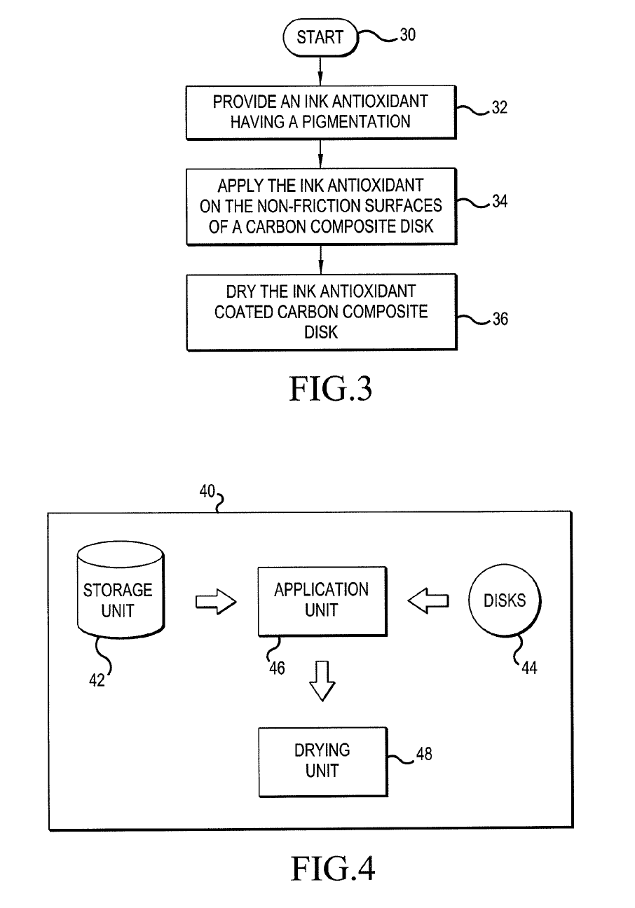

FIG. 3 is a flow diagram illustrating an exemplary method of application process and post-cure in accordance with one embodiment. The process flow starts at 30 and an ink antioxidant having a pigmentation is provided at step 32. In step 34, the ink antioxidant is applied as an antioxidant coating on the non-friction surfaces of a carbon composite disk. The non-friction surfaces of the carbon composite disk may be uncoated of an existing antioxidant coating or coated of an existing antioxidant. In step 36, the ink antioxidant coated carbon composite disk is dried. The ink antioxidant coated carbon composite disk may be dried in a room temperature or a slight version of char or furnace.

The application process as illustrated in FIG. 3 can be performed by a person or a system. It is especially advantageous when the carbon composite disks are applied by a person since the pigmentation of the ink provides contemporaneous visual detection, which allows the person to apply a uniform and even coating on the disk. In addition, the person can easily control the amount of coating, i.e. the thickness of coating, via visual detection of the ink.

FIG. 4 illustrates a system 40 for application of ink antioxidant to the non-friction surfaces of a carbon composite disk and the post-cure in an embodiment. In the system, the ink antioxidant is stored in an ink storage unit 42. The stored ink antioxidant in the ink antioxidant storage unit 42 and carbon composite disks 44 are provided to an applying unit 46, which sprays or brushes the ink antioxidant on the non-friction surfaces of the carbon composite disks 44. The system 40 also provides a drying unit 48 that dries the ink antioxidant coated carbon composite disks in room temperature or in a slight version of char or furnace. All or parts of the system may be automated.

While the present invention has been described with respect to a detailed example of its implementation, the invention is capable of numerous modifications, rearrangements, and alternations, and such are intended to be within the spirit and scope of the disclosure and claims.

What is claimed is:

1. A method for antioxidant coating a carbon composite disk comprising:
providing an ink antioxidant having a pigmentation;
applying said ink antioxidant on the non-friction surfaces of said carbon composite disk to create an ink antioxidant coated carbon composite disk; and
drying said ink antioxidant coated carbon composite disk.

2. The method according to claim 1, wherein said carbon composite disk is uncoated by an antioxidant coating prior to said ink antioxidant being applied on the non-friction surfaces of said carbon composite disk.

3. The method according to claim 1, wherein said carbon composite disk is coated by an antioxidant coating prior to said ink antioxidant being applied on the non-friction surfaces of said carbon composite disk.

4. The method according to claim 1, wherein said ink antioxidant contains titanium oxide.

5. The method according to claim 1, wherein said step of drying includes drying said ink coated carbon composite disk in room temperature.

6. The method according to claim 1, wherein said step of drying includes charring said ink antioxidant coated carbon composite disk at a temperature of about 100-150° F.

7. An apparatus for antioxidant coating a carbon composite disk comprising:
a storing unit to store an ink antioxidant having a pigmentation;
an applying unit to apply said stored ink antioxidant on the non-friction surfaces of said carbon composite disk to create an ink antioxidant coated carbon composite disk; and
a drying unit to dry said ink antioxidant coated carbon composite disk.

8. The apparatus according to claim 7, wherein said carbon composite disk is uncoated of an antioxidant coating prior to said ink antioxidant being applied on the non-friction surfaces of said carbon composite disk.

9. The apparatus according to claim 7, wherein said carbon composite disk is coated of an antioxidant coating prior to said ink antioxidant being applied on the non-friction surfaces of said carbon composite disk.

10. The apparatus according to claim 7, wherein said ink antioxidant contains titanium oxide.

11. The apparatus according to claim 7, wherein said drying unit dries said ink antioxidant coated carbon composite disk in room temperature.

12. The apparatus according to claim 7, wherein said drying unit is a char and heats said ink antioxidant coated carbon composite disk at a temperature of about 100-150° F.

13. A method for antioxidant coating a carbon composite disk comprising:
providing an ink antioxidant having a pigmentation;
applying said ink antioxidant on the non-friction surfaces of said carbon composite disk to create an ink antioxidant coated carbon composite disk;
drying said ink antioxidant coated carbon composite disk,
wherein said carbon composite disk is coated by an antioxidant coating prior to said ink antioxidant being applied on the non-friction surfaces of said carbon composite disk, and
wherein said ink antioxidant contains titanium oxide.

14. The method according to claim 13, wherein said step of drying includes drying said ink coated carbon composite disk in room temperature.

15. The method according to claim 13, wherein said step of drying includes charring said ink antioxidant coated carbon composite disk at a temperature of about 100-150° F.
